(19) United States
(12) Patent Application Publication
(10) Pub. No.: US 2026/0195050 A1
(43) Pub. Date: Jul. 9, 2026

(54) HOST MANUAL REFRESH OPTIMIZATION FOR A DATA STORAGE DEVICE

(71) Applicant: Sandisk Technologies, Inc., Milpitas, CA (US)

(72) Inventors: Anup S, Bengaluru (IN); Prabhakar Ballapalle, Bengaluru (IN); Prasanth CH, Bengaluru (IN); Ashok Palaniswamy, Bengaluru (IN); Muruganantham Panneerselvam, Bengaluru (IN)

(21) Appl. No.: 19/011,480

(22) Filed: Jan. 6, 2025

(51) Int. Cl. G06F 3/06

(52) U.S. Cl. CPC G06F 3/0619; G06F 3/064; G06F 3/0679

(57) ABSTRACT

A data storage device includes a data retention risk system that identifies memory blocks having a data retention risk and are candidates for a host manual refresh operation. The data retention risk system identifies memory blocks having a data retention risk by finding memory blocks with valid data. The data retention risk system determines an age of the data stored by the memory block using timestamp information associated with the data and/or the memory block. If the age of the data is over an age threshold, the memory block is initially classified as having a data retention risk. The memory blocks that have been classified as having a data retention risk are further categorized based on a severity of the data retention risk.

### BACKGROUND

In a data storage device, such as a NAND data storage device, data is stored as electrical charges. Over time, these charges dissipate which reduces the integrity of the data and can lead to errors or even data loss.

A host manual refresh is an operation that enables a host device that is associated with the data storage device to refresh the data at periodic intervals. In a host manual refresh operation, the host device sends commands to a controller of the data storage device which causes the controller to relocate the data of specific memory blocks to new memory blocks. This helps improve data retention and minimizes errors, which improves the overall performance of the data storage device.

However, there is currently no reliable method to evaluate memory blocks and/or determine which memory blocks should be refreshed during the host manual refresh. If refresh operations are performed on memory blocks that do not need a refresh, program/erase (P/E) cycles of the memory blocks are increased unnecessarily, which may reduce the lifespan of the data storage device. Additionally, the host device is unaware as to how many memory blocks need to be refreshed. As a result, an amount of time needed to complete the hose manual refresh operation is increased.

Accordingly, it would be beneficial for a data storage device to identify memory blocks that are candidates for a host manual refresh operation and to provide that information to the host device.

### SUMMARY

The present disclosure describes a data storage device, such as a NAND data storage device, having a data retention risk system. The data retention risk system is configured to identify memory blocks of the data storage device that have a data retention risk and, as a result, are candidates for a host manual refresh operation. The data retention risk system is also configured to calculate or determine a number of host manual refresh commands that are needed to complete the host manual refresh operation on the identified memory blocks. As a result, the host device can issue host manual refresh operation commands to refresh memory blocks which are at risk of data retention and therefore reduce program/erase (P/E) cycle counts and reduce the duration of the host manual refresh operation.

As will be described in greater detail below, the data retention risk system identifies memory blocks having a data retention risk by finding memory blocks with valid data. The data retention risk system determines an “age” of the data stored by the memory block. In an example, the age of the data is based, at least in part, on a timestamp or timestamp information that is associated with the data.

If the age of the data is over an age threshold, the memory block is initially classified as having a data retention risk. The memory blocks that have been classified as having a data retention risk are then categorized and/or grouped based on a severity of the data retention risk. For example, the memory blocks are categorized into memory blocks having a high data retention risk, into memory blocks having a medium data retention data risk and into memory blocks having a low data retention risk.

In an example, the data retention risk is based, at least in part, on a bit error rate (BER) associated with the memory block. The categorization information is provided to the host device which enables the host device to select or determine on which memory blocks the host manual refresh operation(s) will be performed. For example, the host device can determine to perform the host manual refresh on memory blocks having a high data retention risk only or perform the host manual refresh on memory blocks having the high data retention risk and the medium data retention risk.

In an example, the data retention risk system can also calculate the number of refresh commands that the host device needs to issue in order to complete the host manual refresh operations. In another example, the data retention risk system also calculates the number of host commands that are needed to complete a full/complete host manual refresh operation.

Accordingly, examples of the present disclosure describe a method that includes identifying one or more memory blocks of a data storage device having valid data. A first timestamp associated with the data storage device is determined and a second timestamp associated with at least one memory block of the one or more memory blocks is also determined. In an example, the second timestamp is stored as metadata in the at least one memory block. The first timestamp is compared to the second timestamp to determine a difference between the first timestamp and the second timestamp. The difference between the first timestamp and the second timestamp is compared to a timestamp difference threshold. The method also includes determining based, at least in part, on the comparing the difference between the first timestamp and the second timestamp to the timestamp difference threshold, whether the at least one memory block has a data retention risk. The at least one memory block is categorized based on a severity of the data retention risk and the categorization of the severity of the at least one memory block is provided to a host device. This enables the host device to determine whether to initiate a host manual refresh operation on the at least one memory block.

The present disclosure also describes a data storage device that includes a controller and a data retention risk system associated with the controller. The data retention risk system is operable to identify memory blocks of the data storage device having valid data and compare timestamps associated with each of the memory blocks to a timestamp associated with the data storage device to determine which memory blocks have a data retention risk. The data retention risk system categorizes a severity of the data retention risk of the memory blocks having the data retention risk and provides the categorization of the severity of the memory blocks having the data retention risk to a host device. This information enables the host device to determine which memory blocks will be manually refreshed.

Other examples describe a data storage device that includes means for identifying memory blocks of the data storage device having valid data and means for comparing timestamps associated with each of the memory blocks to a timestamp associated with the data storage device to determine which memory blocks have a data retention risk. The data storage device also includes means for categorizing a severity of the data retention risk of the memory blocks having the data retention risk and means for providing the categorization of the severity of the memory blocks having the data retention risk to a host device. This enables the host device to determine which memory blocks will be manually refreshed.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a block diagram of a system that includes a host device and a data storage device according to an example.

FIG. 2A illustrates how a memory die includes a number of memory blocks according to an example.

FIG. 2B illustrates how a memory block includes one or more pages according to an example.

FIG. 2C illustrates how a memory block includes a number of memory cells according to an example.

FIG. 3 illustrates a number of memory blocks of a memory die having either valid or invalid data according to an example.

FIG. 4 illustrates the memory blocks of FIG. 3 being categorized into different data retention risk categories according to an example.

FIG. 5 illustrates a table that indicates a number of host manual refresh commands that are required to complete a host manual refresh cycle based on the amount of valid data in a data storage device according to an example.

FIG. 6 illustrates a table that indicates a number of host manual refresh commands that are required to complete a host manual refresh cycle based on the amount of valid data in a data storage device and based on a data retention risk categorization according to an example.

FIG. 7 illustrates a method for categorizing memory blocks of a data storage device based, at least in part, on a data retention risk of the memory blocks according to an example.

FIG. 8 illustrates a method for determining a number of commands that are needed to complete a host manual refresh operation according to an example.

FIG. 9 is a perspective view of a storage device that includes three-dimensional (3D) stacked non-volatile memory according to an example.

FIG. 10 is a block diagram of a storage device according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. The following detailed description is therefore not to be taken in a limiting sense, and the scope of the present disclosure is defined by the appended claims and their equivalents.

As previously described, data in a data storage device is stored as electrical charges. However, over time, the electrical charges can dissipate (e.g. due to leakage) which reduces the integrity of the data. This can lead to errors or even data loss. To remedy this, data storage devices typically enable host manual refresh operations to periodically refresh the data by moving the data from a source memory block to a destination memory block.

Currently, there are two types of host manual refresh operations-full refresh operations and minimum refresh operations. In a full host manual refresh operation, the host device sends a single refresh command to the data storage device. The data storage device initiates the refresh operations on all of the memory blocks (e.g., memory blocks with valid data) and the refresh operation is executed to completion. During this time, the data storage device does not accept any commands other than those that are related to the host manual refresh operations. For example, the data storage device will only accept refresh status commands and/or refresh abort commands.

In a minimum host manual refresh operation, the host device sends multiple refresh commands to the data storage device. When the data storage device receives the refresh commands, the data storage device will refresh the minimum number of memory blocks during a particular interval. Additionally, the data storage device will not accept any other commands during this particular interval. The host device can send a query about the status of the refresh command and, based on the status, issue additional refresh commands to complete the refresh of the entire device.

However, there are a number of problems with the minimum host manual refresh operations. For example, there is no reliable method to evaluate which memory blocks need to be refreshed to improve data retention. Additionally, nonselective refreshing of all the memory blocks with valid data (regardless of whether the data needs to be refreshed or not) increases program/erase (P/E) cycle count of the memory blocks. This can negatively impact the lifetime of the data storage device. Nonselective host manual refresh operations may also increase the amount of time that is required to complete the host manual refresh operations, which can delay the execution of other commands.

In addition, when executing minimum host manual refresh operations, the host device does not know how many memory blocks will be refreshed during each cycle. Since the host device does not know how many memory blocks will be refreshed, the host device cannot predict or determine the number of host manual refresh commands it needs to issue. In some cases, the data storage device may not have many memory blocks that need to be refreshed, and there is no way to inform the host device about when the host manual refresh operations are complete.

To address the above, the present disclosure describes data storage device having a data retention risk system that improves the processes related to host manual refresh operations (e.g., minimum host manual refresh operations). The data retention risk system identifies memory blocks of the data storage device that have a data retention risk and marks the memory blocks as candidates for a host manual refresh operation. The data retention risk system is also configured to calculate or determine a number of host manual refresh commands that are needed to complete the host manual refresh operations on the identified memory blocks. As a result, the host device can issue host manual refresh operation commands to refresh memory blocks which are at risk of data retention and therefore reduce P/E cycle counts and reduce the duration of the host manual refresh operations.

The data retention risk system identifies memory blocks having a data retention risk by finding memory blocks with valid data. The data retention risk system determines an age of the data stored by the memory block based, at least in part, on a timestamp or timestamp information associated with the data.

If the data retention risk system determines the age of the data is over an age threshold, the data retention risk system classifies the memory block as having a data retention risk. The memory blocks that have been classified as having a data retention risk are then categorized and/or grouped based on a severity of the data retention risk. For example, the memory blocks are categorized into memory blocks having a high data retention risk, into memory blocks having a medium data retention data risk and into memory blocks having a low data retention risk.

In an example, once the memory blocks have been categorized, an order of the memory blocks (e.g., an order in which the memory blocks will be refreshed) in each category may be rearranged based, at least in part, on a factor other than the age or coldness of the data. For example, the order of the memory blocks to be refreshed is based, at least in part, on a determined BER of one or more wordlines and/or signal lines of the memory block.

In another example, the BER is used to determine the severity of the data retention risk and, as a result, the categories in to which each data block will be placed. For example, if the BER is over various thresholds (e.g., a high risk threshold, a medium risk threshold and/or a low risk threshold) the data retention risk system categorizes the memory block accordingly. The categorization information, including the number of memory blocks in one or more of the categories, is provided to the host device. The host device uses the information to select or determine on which memory blocks the host manual refresh operation(s) will be performed and/or the number of host manual refresh operations to execute.

In some examples, the host device can determine to perform the host manual refresh operations on memory blocks having a high data retention risk. In another example, the host device will determine to perform the host manual refresh operations on memory blocks having the high data retention risk and the medium data retention risk.

In an example, the data retention risk system can also calculate the number of refresh commands that the host device needs to issue (e.g., based on the number of memory blocks in each category) in order to complete the host manual refresh operations. In another example, the data retention risk system also calculates the number of host commands that are needed to complete a full/complete host manual refresh operation

In accordance with the above, many technical benefits may be realized including, but not limited to, enabling a host device to issue host manual refresh operations on an as needed basis which reduces P/E cycles and host manual refresh operation cycles when compared with current solutions. Other benefits includes enabling the host device to prioritize refresh operations for memory blocks that are high risk. Additionally, the amount of time required to perform host manual refresh operations will be optimized since the number of commands issues by the host device can be reduced because the host device is informed of the number of commands it needs to issue to complete a host manual refresh operation cycle.

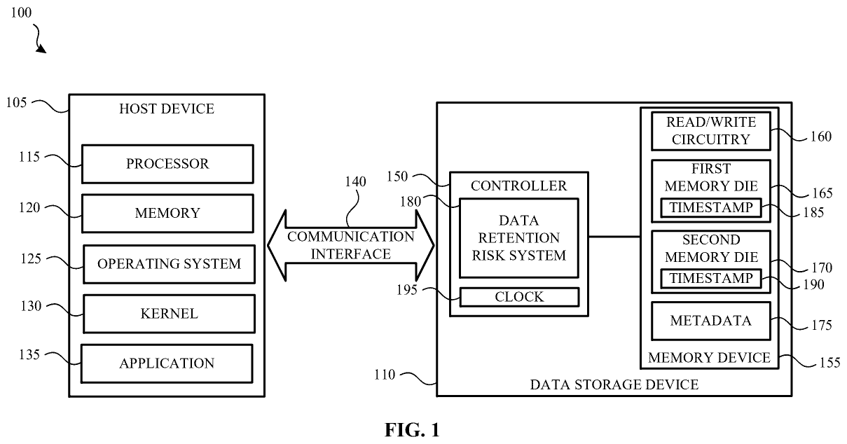

These benefits, along with other examples, will be shown and described in greater detail with respect to FIG. 1-FIG. 10.

FIG. 1 is a block diagram of a system 100 that includes a host device 105 and a data storage device 110 according to an example. In an example, the host device 105 includes a processor 115 and a memory 120 (e.g., main memory). The memory 120 may include or otherwise be associated with an operating system 125, a kernel 130 and/or an application 135.

The processor 115 executes various instructions, such as, for example, instructions from the operating system 125 and/or the application 135. The processor 115 may include circuitry such as a microcontroller, a Digital Signal Processor (DSP), an Application-Specific Integrated Circuit (ASIC), a Field Programmable Gate Array (FPGA), hard-wired logic, analog circuitry and/or various combinations thereof. In an example, the processor 115 may include a System on a Chip (SoC).

In an example, the memory 120 can be used by the host device 105 to store data. The data that is used, or executed by, the processor 115. Data stored in the memory 120 may include instructions provided by the data storage device 110 via a communication interface 140. The data stored in the memory 120 may also include data used to execute instructions from the operating system 125 and/or one or more applications 135. The memory 120 may be a single memory or may include multiple memories, such as, for example one or more non-volatile memories, one or more volatile memories, or a combination thereof.

In an example, the operating system 125 may create a virtual address space for the application 135 and/or other processes executed by the processor 115. The virtual address space may map to locations in the memory 120. The operating system 125 may also include or otherwise be associated with a kernel 130. The kernel 130 may include instructions for managing various resources of the host device 105 (e.g., memory allocation), handling read and write requests and so on.

The communication interface 140 communicatively couples the host device 105 and the data storage device 110. The communication interface 140 may be a Serial Advanced Technology Attachment (SATA), a PCI express (PCIe) bus, a Small Computer System Interface (SCSI), a Serial Attached SCSI (SAS), Ethernet, Fibre Channel, or Wi-Fi. As such, the host device 105 and the data storage device 110 need not be physically co-located and may communicate over a network such as a Local Area Network (LAN) or a Wide Area Network (WAN), such as the internet. In addition, the host device 105 may interface with the data storage device 110 using a logical interface specification such as Non-Volatile Memory express (NVMe) or Advanced Host Controller Interface (AHCI).

The data storage device 110 includes a controller 150 and a memory device 155. In an example, the controller 150 is communicatively coupled to the memory device 155. In an example, the memory device 155 includes one or more memory dies (e.g., first memory die 165 and second memory die 170). Although memory dies are specifically mentioned, the memory device 155 may include any non-volatile memory device, storage device, storage elements or storage medium including NAND flash memory cells and/or NOR flash memory cells.

The memory cells can take the form of solid-state (e.g., flash) memory cells and can be one-time programmable, few-times programmable, or many-times programmable. Additionally, the memory cells may be single-level cells (SLCs), multi-level cells (MLCs), triple-level cells (TLCs), quad-level cells (QLCs), penta-level cells (PLCs), and/or use any other memory technologies. The memory cells may be arranged in a two-dimensional configuration or a three-dimensional configuration.

In an example, the data storage device 110 is attached to or embedded within the host device 105. In another example, the data storage device 110 is implemented as an external device or a portable device that can be communicatively or selectively coupled to the host device 105.

In yet another example, the data storage device 110 is a component (e.g., a solid-state drive (SSD)) of a network accessible data storage system, a network-attached storage system, a cloud data storage system, or the like.

As indicated above, the memory device 155 of the data storage device 110 includes a first memory die 165 and a second memory die 170. Although two memory dies are shown, the memory device 155 may include any number of memory dies (e.g., one memory die, two memory dies, eight memory dies, or another number of memory dies). In an example, each memory die includes a timestamp or timestamp information. For example, the first memory die 165 includes a first timestamp 185 or first timestamp information and the second memory die 170 includes a second timestamp 190 or second timestamp information.

In an example, the timestamps are generated for each memory block or series of memory blocks in each of the memory dies. Each timestamp indicates when data stored by the memory block and/or the memory die has been written and/or refreshed. Thus, the controller 150 is able to determine an age of the data based, at least in part, on the timestamp information and/or by comparing the timestamp information to clock or timestamp information of the host device 105.

In an example, the timestamps are generated using an internal clock/counter 195 associated with the controller 150 and/or the data retention risk system 180. The clock 195 is synchronized with a clock/counter of the host device 105. For example, the clock 195 is synchronized with the clock of the host device 105 using a command interface or the communication interface 140. In an example, time synchronizations between the clock of the host device 105 and the clock 195 of the controller 150 are triggered upon each power cycle and/or upon the occurrence of a deep power down exit. Although specific examples are given, the time synchronization may occur at other times.

The memory device 155 also includes support circuitry. In an example, the support circuitry includes read/write circuitry 160. The read/write circuitry 160 supports the operation of the memory dies of the memory device 155. Although the read/write circuitry 160 is depicted as a single component, the read/write circuitry 160 may be divided into separate components, such as, for example, read circuitry and write circuitry. The read/write circuitry 160 may be external to the memory dies of the memory device 155. In another example, one or more of the memory dies may include corresponding read/write circuitry 160 that is operable to read data from and/or write data to storage elements within one individual memory die independent of other read and/or write operations on any of the other memory dies.

In an example, one or more of the first memory die 165 and the second memory die 170 include one or more planes and each plane may have one or more memory blocks. In an example, each memory block includes one or more memory cells. A block of memory cells is the smallest number of memory cells that are physically erasable together. In an example and for increased parallelism, each of the blocks may be operated or organized in larger blocks or metablocks. For example, one block from different planes of memory cells may be logically linked together to form a metablock.

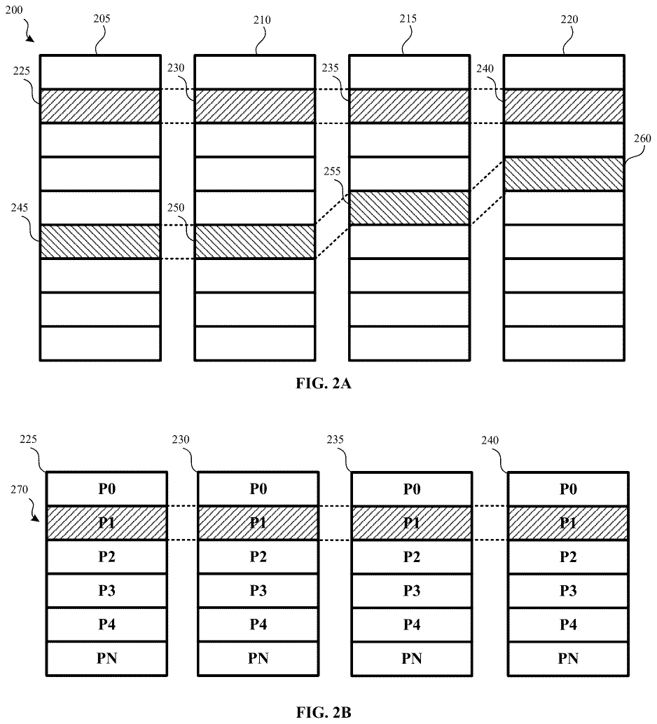

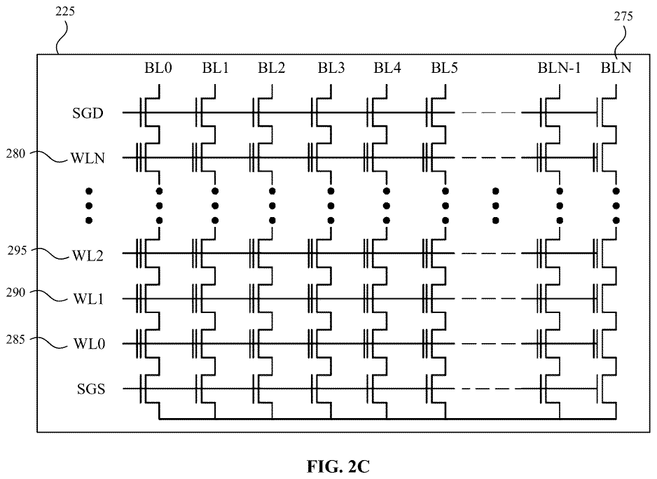

For example and referring to FIG. 2A, a memory device 200 (e.g., a storage element, a memory die, a non-volatile memory device) includes four planes or sub-arrays (e.g., a first plane 205, a second plane 210, a third plane 215, and a fourth plane 220). In an example, the planes are integrated on a single memory die, are provided on two different memory dies (e.g., two planes on each memory die) or are provided on four separate memory dies. Although four planes are shown and described, the memory device 200 may have any number of planes and/or memory dies.

In an example, the planes are divided into memory blocks consisting memory cells. As shown in FIG. 2A, the rectangles represent each memory block, such as memory block 225, memory block 230, memory block 235 and memory block 240. There may be dozens or hundreds of memory blocks in each plane of the memory device 200. In an example, each memory block is a unit of erase and is sometimes referred to as an erase block. For example, memory block 225, memory block 230, memory block 235 and memory block 240 include a minimum number of memory cells that are erased together.

In addition, various memory blocks may be logically linked or grouped together (e.g., using a table in or otherwise accessible by the controller 150) to form a metablock. A metablock may be written to, read from and/or erased as a single unit. For example, memory block 225, memory block 230, memory block 235 and memory block 240 may form a first metablock while memory block 245, memory block 250, memory block 255 and memory block 260 may form a second metablock. The memory blocks used to form a metablock need not be restricted to the same relative locations within their respective planes.

In an example, each memory block may be divided, for operational purposes, into pages of memory cells, such as illustrated in FIG. 2B. For example, the memory cells of memory block 225, memory block 230, memory block 235 and memory block 240 are divided into N different pages (shown as P0-PN). Although a specific number of pages are shown in FIG. 2B, a memory block may have any number of pages of memory cells within each memory block.

In an example, a page is a unit of data programming within the memory block. Each page includes the minimum amount of data that can be programmed at one time. The minimum unit of data that can be read at one time may be less than a page. A metapage 270 is illustrated in FIG. 2B as being formed of one physical page from memory block 225, memory block 230, memory block 235 and memory block 240. In the example, shown, the metapage 270 includes page P1 in each of the four memory blocks. However, the pages of the metapage 270 need not have the same relative position within each of the memory blocks. A metapage 270 may be the maximum unit of programming within a memory block.

The memory blocks disclosed in FIG. 2A-FIG. 2B are referred to herein as physical memory blocks because they relate to groups of physical memory cells. As used herein, a logical memory block is a virtual unit of address space defined to have the same size as a physical memory block. Each logical memory block includes a range of logical memory block addresses (LBAs) that are associated with data received from a host. The LBAs are then mapped to one or more physical memory blocks in the data storage device 110 where the data is physically stored.

As indicated above, each memory block may include any number of memory cells. The design, size, and organization of a memory block may depend on the architecture, design, and application desired for each memory die. In an example, the memory block includes a contiguous set of memory cells that share a plurality of wordlines and bit lines. For example and as shown in FIG. 2C, the memory block 225 includes bit lines BL0-BLN (collectively bit lines 275), where N is a total number of bit lines. Additionally, the memory block 225 includes wordlines WL0-WLN (collectively wordlines 280), where N is a total number of wordlines. In an example, multiple memory blocks can share the same bit line.

A wordline 280 may function as a single-level-cell (SLC) wordline, a multi-level-cell (MLC) wordline, a tri-level-cell (TLC) wordline, a quad-level cell (QLC) wordline, a penta-level cell (PLC) wordline and so on. Additionally, each memory cell may be programmable to a state (e.g., a threshold voltage in a flash configuration or a resistive state in a resistive memory configuration) that indicates one or more values.

In the example shown in FIG. 2C, four memory cells are connected in series to form a NAND string. Although four memory cells are depicted, any number of memory cells (e.g., 16, 32, 64, 128, 256 or any other number or memory cells) may be used. One terminal of the NAND string is connected to a corresponding bit line via a drain select gate (connected to select gate drain line SGD) and another terminal of the NAND string is connected to a source line via a source select gate (connected to select gate source line SGS). Additionally, although eight bit lines are shown in FIG. 2C, any number of bit lines may be used.

As previously described, the data storage device 110 also include a controller 150. Although a single controller 150 is shown, the data storage device 110 can include multiple controllers. In such an example, a first controller executes a first number and/or type of commands while a second controller executes a second number and/or type of commands. The controllers may operate in parallel and/or independently.

The controller 150 is communicatively coupled to the memory device 155 via a bus, an interface or other communication circuitry. In an example, the communication circuitry may include one or more channels to enable the controller 150 to communicate with the first memory die 165 and/or the second memory die 170 of the memory device 155. In another example, the communication circuitry may include multiple distinct channels which enables the controller 150 to communicate with the first memory die 165 independently and/or in parallel with the second memory die 170 of the memory device 155.

The controller 150 receives data and/or instructions from the host device 105. In an example, the controller 150 can receive one or more host manual refresh commands from the host device 105. The controller 150 also sends data to the host device 105. For example, the controller 150 can send information regarding which memory blocks of the memory dies have data retention risks, a categorization of the memory blocks having the data retention risk, information corresponding to an amount or number of refresh commands the host device 105 should issue to complete the host manual refresh operations and/or a status of the host manual refresh operations. In examples, the controller 150 sends data to and/or receives data from the host device 105 via the communication interface 140. The controller 150 also sends data and/or commands to, and/or receive data from, the memory device 155. The controller 150 can also determine timestamp information associated with the various memory blocks and/or memory dies.

The controller 150 sends data and a corresponding write command to the memory device 155 to cause the memory device 155 to store data at a specified address (or a memory die) of the memory device 155. In an example, the write command specifies a physical address of a portion of the memory device 155. In an example, when data is written to the memory die (or to one or more memory blocks of the memory die), timestamp information associated with a time at which the data is written is set and/or recorded. As will be explained in greater detail herein, the timestamp information may be used to determine whether one or more memory blocks of the memory dies have a data retention risk. This information may be stored as metadata 175.

The controller 150 also sends data and/or commands associated with one or more background scanning operations, garbage collection operations, and/or wear leveling operations. The controller 150 also sends one or more read commands to the memory device 155. In an example, the read command specifies the physical address of a portion of the memory device 155 at which the data is stored. The controller 150 may also track the number of program/erase (P/E) cycles or other programming operations that have been performed on or by the memory device 155 and/or on or by the memory dies of the memory device 155. This information may also be stored as metadata 175.

The controller 150 also includes, or is otherwise associated with, a data retention risk system 180. In an example, the data retention risk system 180 is a packaged functional hardware unit designed for use with other components/systems. In another example, the data retention risk system 180 is a portion of a program code (e.g., software or firmware) executable by a processor or processing circuitry. In yet another example, the data retention risk system 180 is a self-contained hardware and/or software component that interfaces with other components and/or systems. Although the data retention risk system 180 is shown as being part of the controller 150, the data retention risk system 180 may be separate from the controller 150.

In an example, the data retention risk system 180 is operable, along with the controller 150, to determine whether one or more memory blocks of one or more memory dies have data retention risks. For example, in response to a received command (e.g., from the host device 105), the data retention risk system 180 determines, based at least in part, on timestamp information, one or more memory block of one or more of the memory dies that have a data retention risk.

For example, the received command may be a manual host refresh command that is issued from the host device 105. In response to receiving the command, the data retention risk system 180 analyzes one or more memory blocks of the first memory die 165 and/or one or more memory blocks of the second memory die 170 to determine which memory blocks have valid data. In an example, the data retention risk system 180 determines whether a memory block has valid data by analyzing the logical addresses of the data written in the memory block to determine whether the memory blocks is erased. If the memory block is erased (or the data in the memory block has been rewritten to another memory block), the memory block does not contain valid data. If a memory block does not contain any valid data, the memory block may be categorized or classified as a “no-risk” memory block. The data retention risk system 180 also determines which memory blocks that have valid data have data retention risks.

If the data retention risk system 180 determines the memory blocks have valid data, timestamp information associated with one or more of the memory blocks is determined. The data retention risk system 180 compares the timestamp information of the one or more memory blocks to the timestamp information associated with the host device 105. The data retention risk system 180 then determines the difference between the timestamp information of the memory blocks and the timestamp information associated with the host device 105 to determine an age of the data stored in the memory blocks. In an example, the age of the data in a memory block is a difference between the current time in a timer associated with the host device 105 and the time when the data was written on the memory block. In an example, the age of the data is determined when the host device 105 issues a command to the data retention risk system 180 to determine the retention risk of data stored by one or more memory blocks.

In response to receiving the command from the host device 105, the data retention risk system 180 compares the age of the data (e.g., the difference in the timestamps) to a timestamp difference threshold. If the age of the data in the memory block is above the timestamp difference threshold, the memory block (or the data stored in the memory block) is marked or identified as having a data retention risk. However, if the age of the data in the memory block is below the timestamp difference threshold, the memory block (or the data) is not marked or is identified as not having a data retention risk.

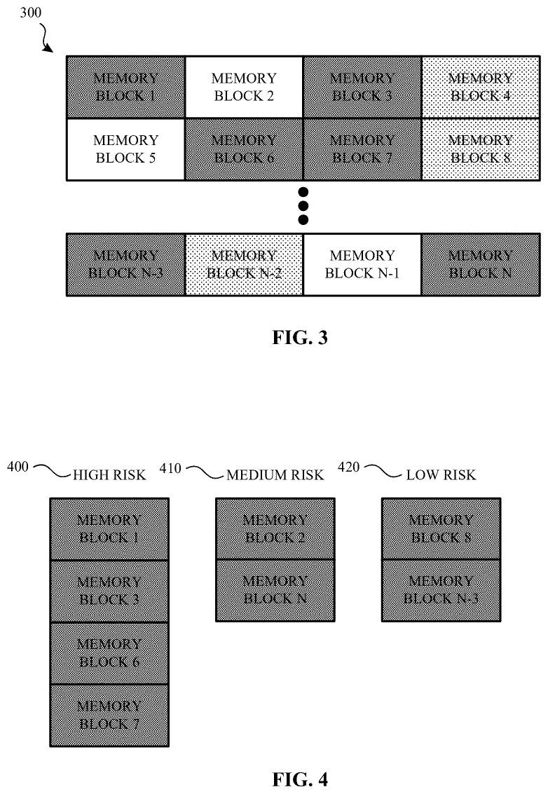

For example and referring to FIG. 3, FIG. 3 illustrates a number of memory blocks 300 of a memory die having either valid or invalid data according to an example. In an example, the memory blocks 300 are from the same memory die (e.g., the first memory die 165 (FIG. 1)). In another example, some of the memory blocks are from a first memory die (e.g., the first memory die 165) and some of the memory blocks are from a second memory die (e.g., the second memory die 170). In some examples, the data stored by the memory blocks is random data. In other examples, the data stored in the memory blocks is sequential data.

In an example, when the data retention risk system 180 (FIG. 1) receives a host manual refresh command from the host device, the data retention risk system 180 analyzes the memory blocks 300 to determine which memory blocks have valid data. The data retention risk system 180 also determines, of the memory blocks that have valid data, which memory blocks have a data retention risk (such as previously described).

In this example, the data retention risk system 180 determines that Memory Block 1, Memory Block 3, Memory Block 4, Memory Block 6, Memory Block 7, Memory Block 8, Memory Block N-3, Memory Block N-2 and Memory Block N have valid data. In this example, Memory Block 2, Memory Block 5 and Memory Block N-1 do not have valid data.

When the memory blocks having valid data are identified, the data retention risk system 180 may generate a bitmap that indicates which memory blocks have valid data (or the memory blocks that should be refreshed). The data retention risk system 180 then determines the age of the data in each of the memory blocks. In this example, Memory Block 1, Memory Block 3, Memory Block 6, Memory Block 7, Memory Block N-3 and Memory Block N have valid data and have an age that exceeds the timestamp difference threshold (which is indicated by the darker shading) while Memory Block 4, Memory Block 8 and Memory Block N-2 have valid data that does not exceed the timestamp difference threshold (which is indicated by the lighter shading).

The data retention risk system 180 is also configured to categorize the memory blocks into different categories based, at least in part, on a risk level associated with the data retention risk. In one example, the categorization is based, at least in part, on the age of the data. In another example, the memory blocks are categorized based, at least in part, on a bit error rate (BER) of one or more wordlines and/or signal lines within the memory block. In yet another example, an order of the memory blocks in a category is based, at least in part, on the BER associated with the memory block. Regardless of how the categorization is determined, the data retention risk system 180 is configured to categorize the memory blocks into a high risk category, a medium risk category and a low risk category. In the examples that follow, the data retention risk system 180 analyzes a bit error rate (BER) of one or more wordlines and/or signal lines within the memory block to determine which category a memory block belongs.

If the BER of the memory block exceeds a first BER threshold, the memory block is categorized in the high risk category. If the BER of the memory block does not exceed the first BER threshold but exceeds a second BER threshold, the memory block is categorized in the medium risk category. If the BER of the memory block does not exceed the second BER threshold but exceeds a third BER threshold, the memory block is categorized in the low risk category.

FIG. 4 illustrates the memory blocks of FIG. 3 being categorized into different data retention risk categories according to an example. In this example, some of the memory blocks (e.g., memory blocks having a BER over the first BER threshold) were identified as high risk 400 or as having a high risk for losing data. In an example, the memory blocks that are identified as high risk are Memory Block 1, Memory Block 3, Memory Block 6 and Memory Block 7.

In an example, the order in which the memory blocks are refreshed may be based on, or may be rearranged based on, a BER associated with each memory block. For example, if the BER of Memory Block 7 is higher than Memory Block 3 and Memory Block 1, but less than Memory Block 6, the order of the memory blocks would be Memory Block 6, Memory Block 7, Memory Block 1 and Memory Block 3 (presuming Memory Block 1 has a higher BER when compared with Memory Block 3). In another example, the order is based on the age of the data. In yet another example, the memory blocks are ordered sequentially.

Referring back to the example, other memory blocks (e.g., memory blocks having a BER over the second BER threshold but not the first BER threshold) were identified as medium risk 410 or as having a medium risk for losing data. In this example, the memory blocks that are identified as medium risk are Memory Block 2 and Memory Block N. These memory blocks may be ordered in a similar manner such as previously described.

Additionally, memory blocks (e.g., memory blocks having a BER over the first BER threshold but not the second BER threshold) were identified as low risk 420 or as having a low risk for losing data. In this example, the memory blocks that are identified as low risk are Memory Block 8 and Memory Block N-3. These memory blocks may be ordered in a similar manner such as previously described.

Referring back to FIG. 1, when the memory blocks are categorized, the data retention risk system 180 provides the categorization information to the host device 105. In an example, the categorization information also includes a number, or a percentage, of memory blocks in each category. As a result, the host device 105 can determine on which memory blocks the host manual refresh operations are to be executed and how many host manual refresh commands need to be issued. For example, the host device 105 may determine to execute host manual refresh operations on the memory blocks in order of highest risk to lowest risk. In another example, the host device 105 may determine to execute host manual refresh operations only on the memory blocks in the high risk category. In another example, the host device 105 may determine to execute host manual refresh operations on the memory blocks in the high risk category and the medium risk category. In an example, the categorization of each memory block may be stored as metadata 175.

When the host device 105 determines to execute host manual refresh operations on the various memory blocks based on the categorization, and determines the number of percentage of memory blocks that will need to be refreshed, the host device 105 sends host manual refresh operation commands to the controller 150 and/or the data retention risk system 180 and refresh the various memory blocks.

In an example, the data retention risk system 180 is also configured to inform the host device 105 about the status the host manual refresh operations. The data retention risk system 180 may provide this information generally (e.g., for all host manual refresh operations regardless of the risk categorization) or based on the risk categorization.

For example and as previously described, in current solutions, a host device does not know how many memory blocks will be refreshed during each host manual refresh cycle. As a result, the host device cannot predict the number of host manual refresh commands that should be issued, nor does it know a total completion time. As a result, the host device 105 issues the maximum number of refresh command each host manual refresh cycle.

To address this, the data retention risk system 180 is configured to provide status updates to the host device 105. The status updates are used by the host device 105 to determine a number of host manual refresh commands to issue. For example, when a first host manual refresh command is received by the controller 150, the data retention risk system 180 determines which memory blocks have valid data (such as previously described).

The data retention risk system 180 then generates a bitmap that indicates which physical blocks are to be refreshed. In an example and as previously described, the bitmap may generally indicate which memory blocks are to be refreshed (e.g., without regard to the risk categorization) or may indicate which memory blocks are to be refreshed based on a risk categorization.

The data retention risk system 180 then calculates the valid metablocks or flash memory units (FMU's) for the memory blocks that are selected for the refresh operations. The data retention risk system 180 may also calculate the number of host commands that are required to complete all of the refresh operations. This information is then provided to the host device 105.

For example, the host device 105 issues a get data retention risk command. The data risk retention system 180 returns the memory blocks in the various data retention risk categories (e.g., high, medium, low). When this information is received, the host device 105 determines or sees that there are memory blocks in various risk categories (e.g., high and/or high and medium) and therefore proceeds to issue a host manual refresh command.

Upon receiving the host manual refresh command, the data risk retention system 180 performs the internal refresh on the memory block with highest data retention risk (e.g. based on the BER of the memory block). The host device 105 also checks for an amount of refresh of refresh commands internally processed by the data risk retention system 180 using an additional command, and the data risk retention system 180 returns the amount of refreshed data. As a result, the host device 105 knows the amount of data in high risk categories and amount of data refreshed per host manual refresh command. The host device 105 uses this information to extrapolate the number of host manual refresh commands that are to be issued to refresh the memory blocks in the high risk category (or the high and medium risk categories).

For example, the data retention risk system 180 identifies the memory blocks having valid data and calculates the number of valid FMU's in the data storage device. When this is determined, the data retention risk system 180 calculates or determines for an X amount of time, how many FMU's can be refreshed and what that percentage is out of one hundred percent. This information is provided to the host device 105. When one refresh command is completed, the host device determines a percentage of commands that are complete. The host device 105 then determines, based on the completion percentage, how many commands are required for a full host manual refresh cycle.

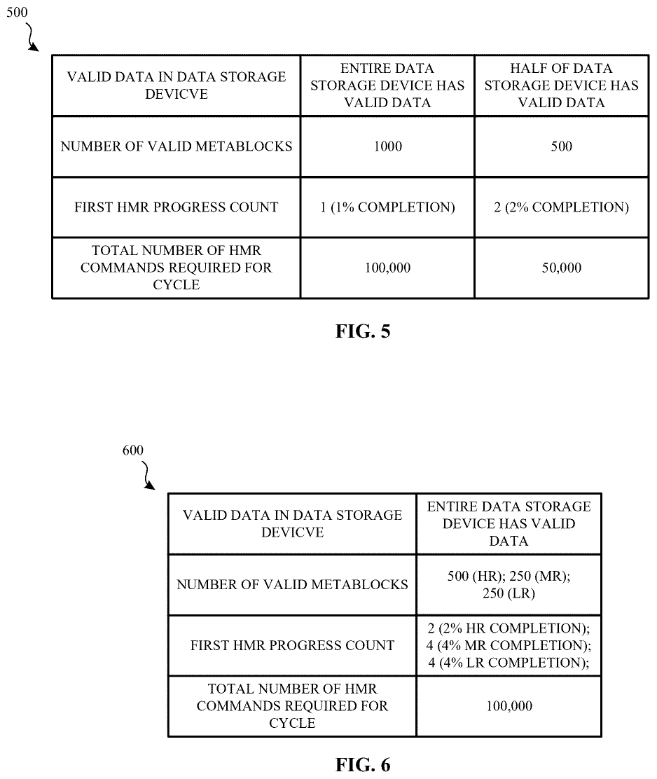

For example, and referring to FIG. 5, FIG. 5 illustrates a table 500 that indicates a number of host manual refresh commands that are required to complete a host manual refresh cycle based on the amount of valid data in a data storage device according to an example. If the data storage device 110 has 1000 memory blocks, and each of the memory blocks has valid data, when a first host manual refresh operation is received from the host device 105, the data retention risk system 180 will indicate that one (1) command was received and/or successfully executed.

In this example, this very first command will indicate an exact progress count for a single host manual refresh command. This information is provided to the host device 105. When the host device receives this information, the host device 105 determines how many additional host manual refresh commands will be required to complete the host manual refresh cycle based, at least in part, on the number of remaining memory blocks to be refreshed and/or based on the completion percentage.

As such, and continuing with the example above, when the first command is received, the host device 105 determines that one percent of the commands were issued and/or executed. As such, in order to complete the cycle, the host device 105 will have to issue 100,000 total commands.

However, if the data retention risk system 180 determines that the memory device 155 has 1000 memory blocks and 500 have valid data, when the first command is received, the data retention risk system 180 determines that execution of the first command caused 2% of the host manual refresh cycle to be complete. As such, when this information is provided to the host device 105, the host device determines that 50,000 additional commands are needed to complete the host manual refresh cycle.

This process may also be repeated based on the various risk categorizations previously described. For example, and referring to FIG. 6, FIG. 6 illustrates a table 600 that indicates a number of host manual refresh commands that are required to complete a host manual refresh cycle based on the amount of valid data in a data storage device and based on a data retention risk categorization according to an example. For example, the data storage device 110 may have 1000 memory blocks, all of which have valid data. However, of the 1000 memory blocks, 500 are categorized as high risk, 250 are categorized as medium risk and 250 are categorized as low risk.

When the first host manual refresh command is received by the data retention risk system 180, the data retention risk system 180 may determine that the first command completed two percent of the host manual refresh operations associated with the high risk memory blocks. As such, when this information is provided to the host device 105, the host device may determine that in order to complete the refresh of the high risk memory blocks, another 50,000 commands should be issued.

Likewise, when the first host manual refresh command is received by the data retention risk system 180, the data retention risk system 180 may determine that the host device should refresh the high risk memory blocks and the medium risk memory blocks. Additionally, the data retention risk system may determine that the first command completed two percent of the host manual refresh operations associated with the high risk memory blocks and four percent of the host manual refresh operations for the medium risk memory blocks. As such, when this information is provided to the host device 105, the host device may determine that in order to complete the refresh of the high risk memory blocks, another 50,000 commands should be issued and in order to complete the refresh of the medium risk memory blocks, another 25,000 commands should be issued.

In yet another example, when the first host manual refresh command is received by the data retention risk system 180, the data retention risk system 180 may determine that the host device should refresh the high risk memory blocks, the medium risk memory blocks and the low risk memory blocks. Additionally, the data retention risk system 180 may determine that the first command completed two percent of the host manual refresh operations associated with the high risk memory blocks, four percent of the host manual refresh operations for the medium risk memory blocks, and four percent of the host manual refresh operations for the low risk memory blocks. As such, when this information is provided to the host device 105, the host device 105 may determine that 50,000 commands are required to complete the host manual refresh operations of the high risk memory blocks, 25,000 commands are required to complete the host manual refresh operations of the medium risk memory blocks, and another 25,000 commands are required to complete the host manual refresh operations of the low risk memory blocks. Although specific numbers are given, these are for example purposes only.

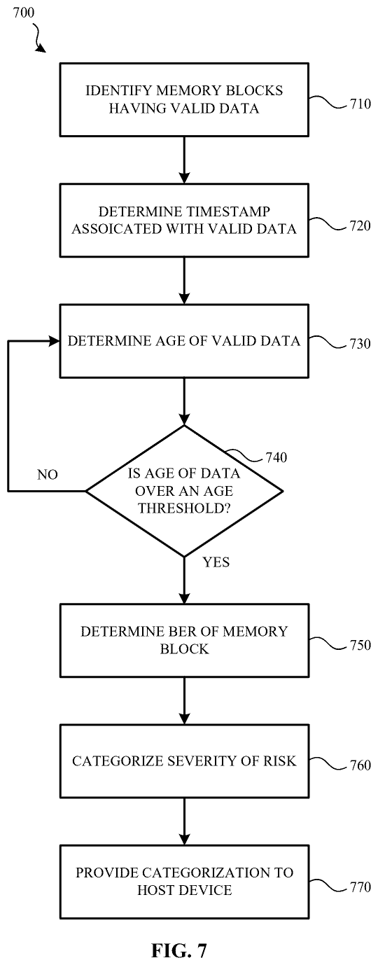

FIG. 7 illustrates a method 700 for categorizing memory blocks of a data storage device based, at least in part, on a data retention risk of the memory blocks according to an example. In an example, the method 700 is performed by a data retention risk system of a data storage device such as, for example, the data retention risk system 180 of a data shown and described with respect to FIG. 1.

In an example, the method 700 begins when a host manual refresh command is received by the data retention risk system. In an example, the host manual refresh operation is provided by a host device, such as, for example, the host device 105 shown and described with respect to FIG. 1. In response to receiving the host manual refresh command, the data retention risk system identifies (710) memory blocks that have valid data.

If the data retention risk system determines a memory block has valid data, the data retention risk system determines (720) timestamp information associated with the memory block. In an example, the timestamp information is metadata that is stored by, or otherwise associated with, the memory block. Additionally, the timestamp information indicates when the data stored by the memory block was written to the memory block.

The data retention risk system compares the timestamp information of the memory block to the timestamp information associated with the host device 105 to determine (730) an age of the data. For example, the data retention risk system determines the difference between the timestamp information of the memory block and the timestamp information associated with the host device to determine the age of the data.

The data retention risk system then determines (740) whether the age of the data is over an age threshold. If the data retention risk system determines the age of the data in the memory block is below the age threshold, the memory block (or the data) is not marked as having a data retention risk or is identified as not having a data retention risk and the method 700 may be repeated for another memory block that is identified as having valid data.

However, if the data retention risk system determines the age of the data in the memory block is above the age threshold, the memory block (or the data) is marked or identified as having a data retention risk. The data retention risk system then determines (750) a bit error rate (BER) associated with the memory block. The data retention risk system then categorizes (760) the severity of the data retention risk based, at least in part, on the BER.

In an example, when the memory blocks are categorized, the data retention risk system provides (770) the categorization information to the host device. The host device can then determine on which memory blocks the host manual refresh operations are to be executed.

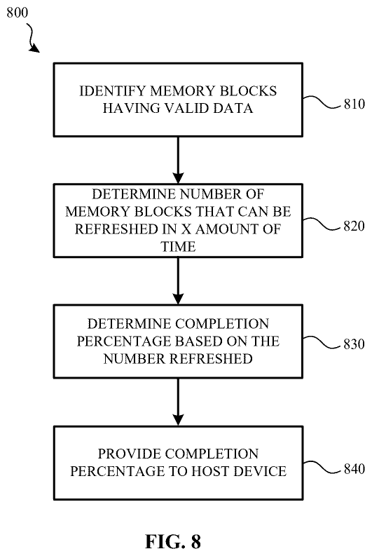

FIG. 8 illustrates a method 800 for determining a number of commands that are needed to complete a host manual refresh operation according to an example. In an example, the method 800 is executed by a data retention risk system of a data storage device such as, for example, the data retention risk system 180 of a data shown and described with respect to FIG. 1.

In an example, the method 800 begins when the data retention risk system receives a first host manual refresh command from a host device (e.g., the host device 105 (FIG. 1). The data retention risk system then identifies (810) which memory blocks have valid data (such as previously described). In an example and as part of this process, the data retention risk system may also generate a bitmap that indicates which memory blocks are to be refreshed.

The data retention risk system then determines (820) the number of memory blocks that can be refreshed in a given amount of time. For example, the data retention risk system determines how many memory blocks can be refreshed in X amount of time.

The data retention risk system then determines (830) a completion percentage of the refresh operations that were completed based, at least in part, on the number of memory blocks that were (or can be) completed during the X amount of time. This information is then provided (840) to the host device. The host device can then determine how many commands it should issue to complete a full host manual refresh cycle on the memory blocks that have valid data. This process may be repeated any number of times so the host device is aware of how many commands it needs to issue before the host manual refresh cycle is complete.

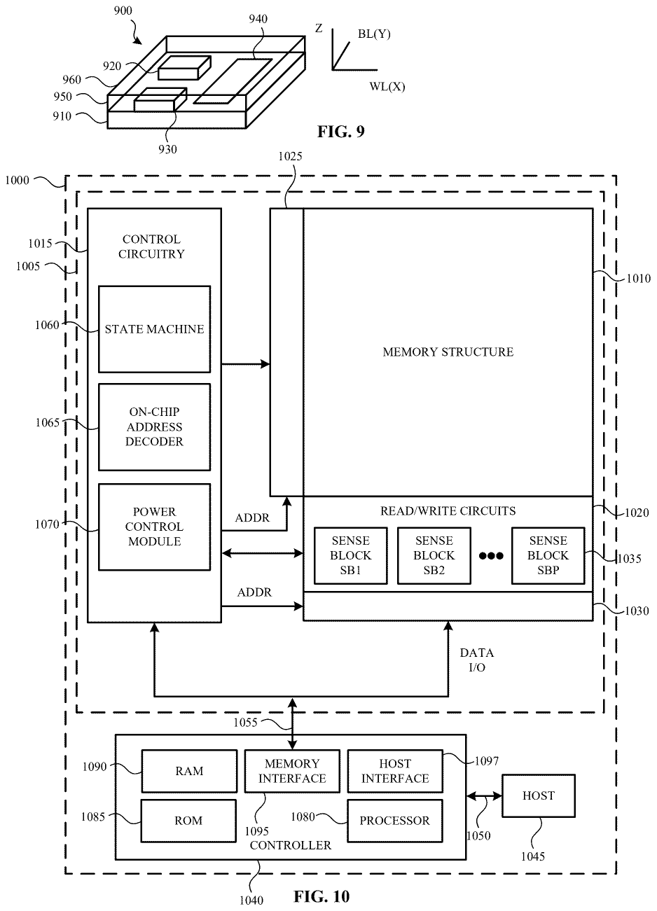

FIG. 9-FIG. 10 describe example storage devices that may be used with or otherwise implement the various features described herein. For example, the storage devices shown and described with respect to FIG. 9-FIG. 10 may include various systems and components that are similar to the systems and components shown and described with respect to FIG. 1. For example, the controller 1022 shown and described with respect to FIG. 10 may be similar to the controller 150 of FIG. 1. Likewise, the memory dies 1008 may be similar to the first memory die 165 and/or the second memory die 170 of FIG. 1.

FIG. 9 is a perspective view of a storage device 900 that includes three-dimensional (3D) stacked non-volatile memory according to an example. In this example, the storage device 900 includes a substrate 910. Blocks of memory cells are included on or above the substrate 910. The blocks include a first block (BLK0 920) and a second block (BLK1 930). Each block is formed of memory cells (e.g., non-volatile memory elements). The substrate 910 also includes a peripheral area 940 having support circuits that are used by the first block and the second block.

The substrate 910 also carries circuits under the blocks, along with one or more lower metal layers which are patterned in conductive paths to carry signals from the circuits. In an example, the blocks are formed in an intermediate region 950 of the storage device 900. The storage device also includes an upper region 960. The upper region 960 includes one or more upper metal layers that are patterned in conductive paths to carry signals from the circuits. Each block of memory cells includes a stacked area of memory cells. In an example, alternating levels of the stack represent wordlines. While two blocks are depicted, additional blocks may be used and extend in the x-direction and/or the y-direction.

In an example, a length of a plane of the substrate 910 in the x-direction represents a direction in which signal paths for wordlines or control gate lines extend (e.g., a wordline or drain-end select gate (SGD) line direction) and the width of the plane of the substrate 910 in the y-direction represents a direction in which signal paths for bit lines extend (e.g., a bit line direction). The z-direction represents a height of the storage device 900.

FIG. 10 is a functional block diagram of a storage device 1000 according to an example. In an example, the storage device 1000 is similar to the 3D stacked non-volatile storage device 900 shown and described with respect to FIG. 9. In an example, the components depicted in FIG. 10 are electrical circuits. In an example, the storage device 1000 includes one or more memory dies 1005. Each memory die 1005 includes a three-dimensional memory structure 1010 of memory cells (e.g., a 3D array of memory cells), control circuitry 1015, and read/write circuits 1020. In another example, a two-dimensional array of memory cells may be used. The memory structure 1010 is addressable by wordlines using a first decoder 1025 (e.g., a row decoder) and by bit lines using a second decoder 1030 (e.g., a column decoder). The read/write circuits 1020 may also include multiple sense blocks 1035 including SB1, SB2, . . . , SBp (e.g., sensing circuitry) which allow pages of the memory cells to be read or programmed in parallel. The sense blocks 1035 may include bit line drivers.

In an example, a controller 1040 is included in the same storage device 1000 as the one or more memory dies 1005. In another example, the controller 1040 is formed on a die that is bonded to a memory die 1005, in which case each memory die 1005 may have its own controller 1040. In yet another example, a controller die controls all of the memory dies 1005. Although a single controller 1040 is shown, the storage device 1000 can include multiple controllers with each controller responsible for different operations described herein.

Commands and data are transferred between a host 1045 and the controller 1040 using a data bus 1050. Additionally, commands and data are transferred between the controller 1040 and one or more of the memory dies 1005 by way of lines 1055. In one example, the memory die 1005 includes a set of input and/or output (I/O) pins that connect to lines 1055.

The memory structure 1010 also includes one or more arrays of memory cells. The memory cells are arranged in a three-dimensional array or a two-dimensional array. The memory structure 1010 includes any type of non-volatile memory that is formed on one or more physical levels of arrays of memory cells having an active area disposed above a silicon substrate. The memory structure 1010 may be in a non-volatile memory device having circuitry associated with the operation of the memory cells, whether the associated circuitry is above or within the substrate.

The control circuitry 1015 works in conjunction with the read/write circuits 1020 to perform memory operations (e.g., erase, program, read, and others) on the memory structure 1010. The control circuitry 1015 may include registers, ROM fuses, and other devices for storing default values such as base voltages and other parameters.

The control circuitry 1015 also includes a state machine 1060, an on-chip address decoder 1065 and a power control module. The state machine 1060 provides chip-level control of various memory operations, such as selecting a memory block for programming. The state machine 1060 is programmable by software. In another example, the state machine 1060 does not use software and is completely implemented in hardware (e.g., electrical circuits).

The on-chip address decoder 1065 provides an address interface between addresses used by host 1045 and/or the controller 1040 to a hardware address used by the first decoder 1025 and the second decoder 1030. The power control module 1070 controls power and voltages that are supplied to the wordlines and bit lines during memory operations. The power control module 1070 may include drivers for wordline layers in a 3D configuration, select transistors (e.g., SGS and SGD transistors) and source lines. The power control module 1070 may include one or more charge pumps for creating voltages. In an example, the power control module 1070 helps ensure wordlines of the grown bad block described herein are programmed at the desired levels.

The control circuitry 1015, the state machine 1060, the on-chip address decoder 1065, the first decoder 1025, the second decoder 1030, the power control module 1070, the sense blocks 1035, the read/write circuits 1020, and/or the controller 1040 may be considered one or more control circuits and/or a managing circuit that perform some or all of the operations described herein.

In an example, the controller 1040, is an electrical circuit that may be on-chip or off-chip. Additionally, the controller 1040 may include one or more processors 1080, ROM 1085, RAM 1090, memory interface 1095, and host interface 1097, all of which may be interconnected. In an example, the one or more processors 1080 is one example of a control circuit. Other examples can use state machines or other custom circuits designed to perform one or more functions. Devices such as ROM 1085 and RAM 1090 may include code such as a set of instructions. One or more of the processors 1080 may be operable to execute the set of instructions to provide some or all of the functionality described herein.

Alternatively or additionally, one or more of the processors 1080 may access code from a memory device in the memory structure 1010, such as a reserved area of memory cells connected to one or more wordlines. The memory interface 1095, in communication with ROM 1085, RAM 1090, and one or more of the processors 1080, may be an electrical circuit that provides an electrical interface between the controller 1040 and the memory die 1005. For example, the memory interface 1095 may change the format or timing of signals, provide a buffer, isolate from surges, latch I/O, and so forth.

The one or more processors 1080 may issue commands to control circuitry 1015, or any other component of memory die 1005, using the memory interface 1095. The host interface 1097, in communication with the ROM 1085, the RAM 1095, and the one or more processors 1080, may be an electrical circuit that provides an electrical interface between the controller 1040 and the host 1045. For example, the host interface 1097 may change the format or timing of signals, provide a buffer, isolate from surges, latch I/O, and so on. Commands and data from the host 1045 are received by the controller 1040 by way of the host interface 1097. Data sent to the host 1045 may be transmitted using the data bus 1050.

Multiple memory elements in the memory structure 1010 may be configured so that they are connected in series or so that each element is individually accessible. By way of a non-limiting example, flash memory devices in a NAND configuration (e.g., NAND flash memory) typically contain memory elements connected in series. A NAND string is an example of a set of series-connected memory cells and select gate transistors.

A NAND flash memory array may also be configured so that the array includes multiple NAND strings. In an example, a NAND string includes multiple memory cells sharing a single bit line and are accessed as a group. Alternatively, memory elements may be configured so that each memory element is individually accessible (e.g., a NOR memory array). The NAND and NOR memory configurations are examples and memory cells may have other configurations.

The memory cells may be arranged in the single memory device level in an ordered array, such as in a plurality of rows and/or columns. However, the memory elements may be arrayed in non-regular or non-orthogonal configurations, or in structures not considered arrays.

In an example, a 3D memory structure may be vertically arranged as a stack of multiple 2D memory device levels. As another non-limiting example, a 3D memory array may be arranged as multiple vertical columns (e.g., columns extending substantially perpendicular to the major surface of the substrate, such as in the y direction) with each column having multiple memory cells. The vertical columns may be arranged in a two-dimensional arrangement of memory cells, with memory cells on multiple vertically stacked memory planes. Other configurations of memory elements in three dimensions can also constitute a 3D memory array.

In another example, in a 3D NAND memory array, the memory elements may be coupled together to form vertical NAND strings that traverse across multiple horizontal memory device levels. Other 3D configurations can be envisioned wherein some NAND strings contain memory elements in a single memory level while other strings contain memory elements which span through multiple memory levels. 3D memory arrays may also be designed in a NOR configuration and in a ReRAM configuration.

Based on the above, examples of the present disclosure describe a method, comprising: identifying one or more memory blocks of a data storage device having valid data; determining a first timestamp associated with the data storage device; determining a second timestamp associated with at least one memory block of the one or more memory blocks, the second timestamp being stored as metadata in the at least one memory block; comparing the first timestamp to the second timestamp to determine a difference between the first timestamp and the second timestamp; comparing the difference between the first timestamp and the second timestamp to a timestamp difference threshold; determining based, at least in part, on the comparing the difference between the first timestamp and the second timestamp to a timestamp difference threshold, whether the at least one memory block has a data retention risk; categorizing a severity of the data retention risk of the at least on memory block; and providing the categorization of the severity of the at least one memory block to a host device to enable the host device to determine whether to initiate a host manual refresh operation on the at least one memory block. In an example, the data retention risk is based, at least in part, on a bit error rate (BER) associated with the at least one memory block. In an example, the method also includes determining a bit error rate (BER) level on at least one wordline of the at least one memory block. In an example, categorizing the severity of the data retention risk of the at least one memory block comprises categorizing the at least one memory block as having at least one of a high data retention risk, a medium data retention risk and a low data retention risk. In an example, the method also includes grouping the at least one memory block with other memory blocks having a similar severity. In an example, identifying the one or more memory blocks of the data storage device having valid data comprises generating a bitmap that indicates which memory blocks of the one or more memory blocks have valid data. In an example, the method also includes determining a total number of memory blocks in the data storage device having valid data; determining a number of memory blocks of the total number of memory blocks that can undergo the host manual refresh operation in a given time period; and providing the determined number of memory blocks to the host device to enable the host device to determine a number of host manual refresh command operations to issue to the data storage device.

Examples also describe a data storage device, comprising: a controller; and a data retention risk system associated with the controller and operable to: identify memory blocks of the data storage device having valid data; compare timestamps associated with each of the memory blocks to a timestamp associated with the data storage device to determine which memory blocks have a data retention risk; categorize a severity of the data retention risk of the memory blocks having the data retention risk; and provide the categorization of the severity of the memory blocks having the data retention risk to a host device to enable the host device to determine which memory blocks will be manually refreshed. In an example, the data retention risk system is further operable to reset the timestamp associated with the data storage device in response to a time synchronization event. In an example, the time synchronization event is at least one of a power cycle event, a power down event and a power up event. In an example, the data retention risk is based, at least in part, on a bit error rate (BER) associated with each of the memory blocks. In an example, categorizing the severity of the data retention risk of the memory blocks having the data retention risk comprises categorizing the memory blocks as having at least one of a high data retention risk, a medium data retention risk and a low data retention risk. In an example, the data retention risk system is further operable to group the memory blocks based, at least in part, on the severity of the data retention risk. In an example, the data retention risk system is further operable to generate a bitmap that indicates which memory blocks have valid data. In an example, the data retention risk system is further operable to: determine a total number of memory blocks having valid data; determine a number of memory blocks of the total number of memory blocks that can be manually refreshed in a given time period; and provide the determined number of memory blocks to the host device to enable the host device to determine a number of host manual refresh command operations to issue to the data storage device.

Examples also describe a data storage device, comprising: means for identifying memory blocks of the data storage device having valid data; means for comparing timestamps associated with each of the memory blocks to a timestamp associated with the data storage device to determine which memory blocks have a data retention risk; means for categorizing a severity of the data retention risk of the memory blocks having the data retention risk; and means for providing the categorization of the severity of the memory blocks having the data retention risk to a host device to enable the host device to determine which memory blocks will be manually refreshed. In an example, thee data storage device also includes means for resetting the timestamp associated with the data storage device in response to a time synchronization event. In an example, the data retention risk is based, at least in part, on a bit error rate (BER) associated with each of the memory blocks. In an example, the means for categorizing the severity of the data retention risk of the memory blocks having the data retention risk categorizes the memory blocks as having at least one of a high data retention risk, a medium data retention risk and a low data retention risk. In an example, the data storage device also includes means for grouping the memory blocks based, at least in part, on the severity of the data retention risk.

One of ordinary skill in the art will recognize that the technology described herein is not limited to a single specific memory structure, but covers many relevant memory structures within the spirit and scope of the technology as described herein and as understood by one of ordinary skill in the art.

The description and illustration of one or more aspects provided in the present disclosure are not intended to limit or restrict the scope of the disclosure in any way. The aspects, examples, and details provided in this disclosure are considered sufficient to convey possession and enable others to make and use the best mode of claimed disclosure.

The claimed disclosure should not be construed as being limited to any aspect, example, or detail provided in this disclosure. Regardless of whether shown and described in combination or separately, the various features (both structural and methodological) are intended to be selectively rearranged, included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this disclosure that do not depart from the broader scope of the claimed disclosure.

Aspects of the present disclosure have been described above with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

References to an element herein using a designation such as “first,” “second,” and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

1. A method, comprising:
identifying one or more memory blocks of a data storage device having valid data;
determining a first timestamp associated with the data storage device;
determining a second timestamp associated with at least one memory block of the one or more memory blocks, the second timestamp being stored as metadata in the at least one memory block;
comparing the first timestamp to the second timestamp to determine a difference between the first timestamp and the second timestamp;
comparing the difference between the first timestamp and the second timestamp to a timestamp difference threshold;
determining based, at least in part, on the comparing the difference between the first timestamp and the second timestamp to a timestamp difference threshold, whether the at least one memory block has a data retention risk;
in response to determining the at least one memory block has a data retention risk:
determining a bit error rate (BER) associated with the at least one memory block;
categorizing a severity of the data retention risk of the at least one memory block based, at least in part, on comparing the BER to one or more BER thresholds; and
providing the categorization of the severity of the at least one memory block to a host device to enable the host device to selectively initiate a host manual refresh operation on the at least one memory block.

2. (canceled)

3. The method of claim 1, further comprising determining a bit error rate (BER) level on at least one wordline of the at least one memory block.

4. The method of claim 1, wherein categorizing the severity of the data retention risk of the at least one memory block comprises categorizing the at least one memory block as having at least one of a high data retention risk, a medium data retention risk and a low data retention risk.

5. The method of claim 1, further comprising grouping the at least one memory block with other memory blocks having a similar severity.

6. The method of claim 1, wherein identifying the one or more memory blocks of the data storage device having valid data comprises generating a bitmap that indicates which memory blocks of the one or more memory blocks have valid data.

7. The method of claim 1, further comprising:
determining a total number of memory blocks in the data storage device having valid data;
determining a number of memory blocks of the total number of memory blocks that can undergo the host manual refresh operation in a given time period; and
providing the determined number of memory blocks to the host device to enable the host device to determine a number of host manual refresh command operations to issue to the data storage device.

8. A data storage device, comprising:
a controller; and
a data retention risk system associated with the controller and operable to:
identify memory blocks of the data storage device having valid data;
determine a bit error rate (BER) associated with each of the memory blocks in response to determining the memory blocks have a data retention risk;
categorize a severity of the data retention risk of the memory blocks based, at least in part, on comparing the BER to one or more BER thresholds; and
provide the categorization of the severity of the data retention risk of the memory blocks to a host device to enable the host device to selectively initiate a host manual refresh operation on the memory blocks.

9. The data storage device of claim 8, wherein the data retention risk system is further operable to reset the timestamp associated with the data storage device in response to a time synchronization event.

10. The data storage device of claim 9, wherein the time synchronization event is at least one of a power cycle event, a power down event and a power up event.

11. (canceled)

12. The data storage device of claim 8, wherein categorizing the severity of the data retention risk of the memory blocks having the data retention risk comprises categorizing the memory blocks as having at least one of a high data retention risk, a medium data retention risk and a low data retention risk.

13. The data storage device of claim 8, wherein the data retention risk system is further operable to group the memory blocks based, at least in part, on the severity of the data retention risk.

14. The data storage device of claim 8, wherein the data retention risk system is further operable to generate a bitmap that indicates which memory blocks have valid data.

15. The data storage device of claim 8, wherein the data retention risk system is further operable to:
determine a total number of memory blocks having valid data;
determine a number of memory blocks of the total number of memory blocks that can be manually refreshed in a given time period; and
provide the determined number of memory blocks to the host device to enable the host device to determine a number of host manual refresh command operations to issue to the data storage device.

16. A data storage device, comprising:
means for identifying memory blocks of the data storage device having valid data;
means for determining a bit error rate (BER) associated with each of the memory blocks in response to determining the memory blocks have a data retention risk;
means for categorizing a severity of the data retention risk of the memory blocks based. at least in part, on comparing the BER to one or more BER thresholds; and
means for providing the categorization of the severity of the memory blocks to a host device to enable the host device to selectively initiate a host manual refresh operation on the memory blocks.

17. The data storage device of claim 16, further comprising means for resetting the timestamp associated with the data storage device in response to a time synchronization event.

18. (canceled)

19. The data storage device of claim 16, wherein the means for categorizing the severity of the data retention risk of the memory blocks having the data retention risk categorizes the memory blocks as having at least one of a high data retention risk, a medium data retention risk and a low data retention risk.

20. The data storage device of claim 16, further comprising means for grouping the memory blocks based, at least in part, on the severity of the data retention risk.

21. The method of claim 1, further comprising ordering the at least one memory block within a risk category based, at least in part, on the BER associated with the at least one memory block.

22. The data storage device of claim 8, wherein the data retention risk system is further operable to provide, to the host device, a number of memory blocks in at least one risk category to enable the host device to determine a number of host manual refresh commands to issue.

23. The data storage device of claim 16, further comprising means for providing, to the host device, a number of memory blocks in at least one risk category to enable the host device to determine a number of host manual refresh commands to issue.
